(19) United States
(12) Patent Application Publication
(10) Pub. No.: US 2015/0020486 A1
(43) Pub. Date: Jan. 22, 2015

(54) FILTER HOUSING AND AIR FILTER UNIT FOR A COMBUSTION ENGINE

(71) Applicant: Scania CV AB, Södertälje (SE)

(72) Inventors: Emil Pettersson, Trosa (SE); Sven-Erik Nyberg, Alvsjo (SE)

(21) Appl. No.: 14/380,754

(22) PCT Filed: Feb. 25, 2013
(86) PCT No.: PCT/SE2013/050161

§ 371 Date: Aug. 25, 2014

(30) Foreign Application Priority Data
Mar. 1, 2012 (SE) 1250192-0

(51) Int. Cl. F02M 35/024; B01D 46/00; F02M 35/04

(52) U.S. Cl. CPC F02M 35/02416; F02M 35/048; B01D 46/0004; B01D 46/0005
USPC 55/478

(57) ABSTRACT

A filter housing (10) for a filter unit (50) with a substantially semicylindrical air filter (52). The housing includes an air inlet (20) and an engine air outlet (40). The filter housing (10) has a top aperture (12) for introducing and taking out the filter unit (50), and a cover (30) to close the top aperture (12), a bottom aperture (16) to be closed and opened by a closed filter bottom (70) of the filter unit (50) being introduced or taken out. Also, a filter unit for such a filter housing is disclosed.

### TECHNICAL FIELD

The invention relates to a filter housing for accommodating a filter unit, comprising an air inlet and an engine air outlet. The invention relates also to a filter unit for such a air filter housing.

### BACKGROUND

In known air filter arrangements for a combustion engine of a truck the filter housing often has a releasable bottom which allows a spent filter unit to be taken out and replaced from below, i.e. from the dirty lower side of the arrangement. Although the filter change takes place from the dirty side, there is still risk that in the limited space under the vehicle the new filter unit may scrape against the dirty region in and outside the filter housing, potentially leading to dirt making its way into the filter unit and thereby to the clean side of the air system, and hence to possible damage to the engine. Such a filter change also involves a considerable amount of work and use of space, particularly as the vehicle has to be raised or placed over a greasing pit or the like in a workshop to provide space for the work involved in the change. The operation may comprise removing the bottom of the filter housing, taking out the spent filter unit, cleaning the inside and bottom of the housing, inserting the new filter unit and refitting the bottom.

### SUMMARY OF THE INVENTION

An object of the invention is to propose a filter arrangement of the kind indicated in the introduction whereby the filter unit can be changed in a simpler way, with little risk of contamination of the clean side of the filter arrangement.

This is achieved by the features indicated in the claims set out below.

In one aspect of the invention, the filter housing has a top aperture for introducing and taking out the filter unit, a bottom aperture arranged to be closed/opened by a closed bottom of the filter unit being introduced/taken out, and a cover to close the top aperture.

This arrangement thus makes it possible for the filter unit to be changed from the upper side of the filter housing, thus facilitating the work and avoiding the need to raise the vehicle or place it on a greasing bridge or over a greasing pit. The bottom aperture also makes it easier for the inside of the filter housing to be cleaned from above so that the dirt removed can make its way out via the bottom aperture. After the cleaning, the downward movement involved in introducing the new filter unit means that no contamination will be carried upwards towards the clean side of the filter housing. The fact that the bottom of the filter unit closes the bottom aperture also means that the filter housing need not have a releasable bottom.

Although other solutions are possible, in one embodiment the engine air outlet is situated in the cover. The cover may in various ways be removable and separable from the remainder of the filter housing to allow filter change, without removing the air ducts between the engine and the cover. The cover may for example be removed by being moved along or pivoted about one or more duct connections. It may also be connected to a flexible duct section such as a bellows, e.g. a narrowing bellows which can be turned inside out like a roll bellows so as to be shorter when the cover is removed far enough to allow filter change from the upper side of the filter housing.

The engine air outlet may then also be covered by a filter element. Such a filter element, which may comprise a filter cloth or a fine-mesh grille on the cover, provides protection against contamination of the clean side with the ducts to the engine when the cover is removed for filter change.

The filter unit according to the invention for a filter housing with an air inlet and an engine air outlet comprises a substantially semicylindrical air filter. The filter unit is distinguished by a closed filter bottom arranged to close the bottom aperture of the filter housing when the filter unit is being introduced into the housing.

The filter unit may have a centering means at a periphery of the filter bottom to engage with an edge of the bottom aperture, making it easy to ensure that filter change causes the filter bottom to reach a correct position.

Although the cover of the filter housing may serve as an upper seal between the dirty and clean sides of the filter unit, the filter unit in one embodiment has also a filter top having a central aperture for the engine air outlet and arranged to close the filter housing's top aperture when the filter unit is being introduced into the filter housing.

The filter top and the filter bottom of a new filter unit may thus delineate and seal the dirty side of the filter housing, i.e. the annular inlet space between the filter and the filter housing, as soon as a new filter unit is put into position in the filter housing, so that there is no risk of the clean side being contaminated when the cover is put back on.

In another embodiment an upper side of the filter top may be configured to delineate in conjunction with a cover of the filter housing an air aperture to an extra air outlet of the filter housing, which aperture extends along a periphery of the engine air outlet. This makes it possible for filtered air to pass from the filter housing to consumers other than the engine, e.g. an air compressor.

The filter unit may have centering means at a periphery of the filter top to engage with an edge of the top aperture, making it easy to ensure that filter change results in the filter top also reaching a correct position.

Other features and advantages of the invention may be indicated by the claims and the description of embodiment examples set out below.

### BRIEF DESCRIPTION OF DRAWINGS

FIG. 1 is a view obliquely from above of an air filter arrangement according to the invention;

FIG. 2 is a longitudinal sectional view corresponding to FIG. 1 with cover open;

FIG. 3 is a longitudinal sectional view approximately as per FIG. 2 with air filter partly pulled out;

FIG. 4 is a detail view, with portions cut away, of an upper portion of an air filter arrangement according to the invention;

FIG. 5 is a detail view, with portions cut away, of a lower portion of an air filter arrangement according to the invention;

FIG. 6 is a side view, with portions cut away, of an upper portion of an air filter arrangement according to the invention with cover closed;

FIG. 7 is a view corresponding to FIG. 6 with cover open; and

FIGS. 8A-8C depict schematically a process of opening the cover of an arrangement substantially according to FIGS. 6 and 7.

Throughout the drawings, the same reference numerals are used for items with same or similar functions.

### DETAILED DESCRIPTION OF EMBODIMENTS

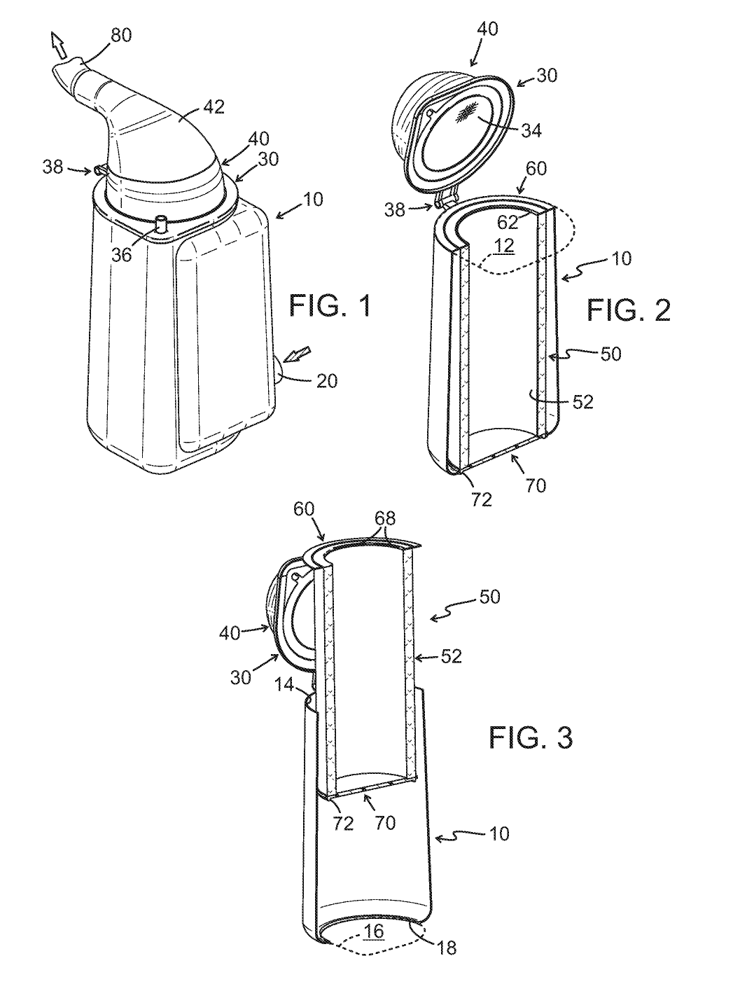

The air filter arrangement depicted in the drawings comprises in a known way an elongate air filter housing 10 for accommodating a filter unit or cartridge 50 comprising a substantially semicylindrical air filter 52. Air which is to be filtered passes through an air inlet 20 (FIG. 1) on the outside of the filter housing 10 into an annular space between the filter unit 50 and the filter housing 10 and, after passing through the filter 52, proceeds through an engine air outlet 40 in a cover 30 on the upper side of the filter housing 10. This engine air outlet 40 is itself intended to be connected to an undepicted air intake of a combustion engine via successive air ducts 42, 80.

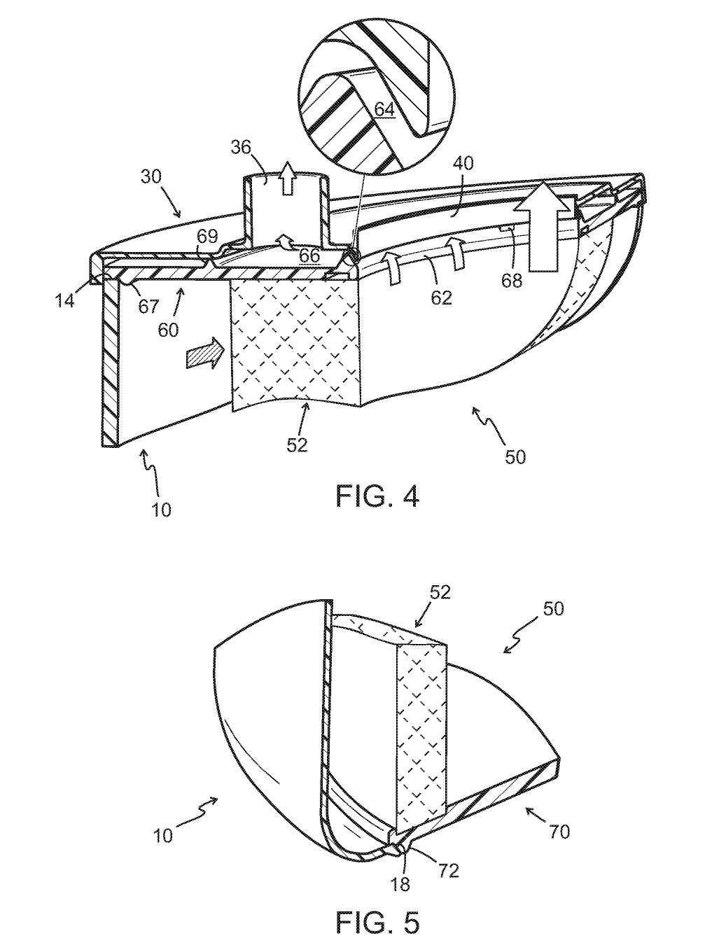

As most clearly depicted in FIG. 4, the filter 52 of the filter unit 50 is connected to a filter top in the form of an upper seal element 60 which has a central aperture 62 coaxial with an inside of the filter 52 and with the air outlet 40. When the filter unit 50 is fitted in the housing 10, the outer periphery of the seal element 60 abuts sealingly against an edge 14 which delineates a top aperture 12 of the housing. Centering means of the filter housing 10 and/or the filter top 60, e.g. an encircling protrusion 67 directed downwards from the underside of the filter top 60, may facilitate and ensure that the filter top reaches a correct position at the upper side of the housing 10.

Between the filter unit's 50 upper seal element 60 and the engine air outlet 40 there is an air aperture 64 (FIG. 4) to an extra air outlet 36. As indicated by the arrows in FIG. 4, part of the filtered air may then also be led to an encircling air duct 66 via an air aperture 64 between the cover 30 and the upper seal element 60 before making its way out through the extra air outlet 36. The air duct 66 may be delineated radially outwards by an encircling ridge 69 which is part of the upper seal element 60 and which abuts sealingly against the cover 30. In the example depicted, the extra air outlet 36, which may distribute filtered air in the arrangement to an undepicted air consumer, e.g. an air compressor, is situated in the filter housing's 10 cover 30. The air aperture 64 extends along a periphery of the engine air outlet 40, with advantage round the whole periphery, in the form of a gap which slopes obliquely outwards and upwards. The width of the gap may be maintained by supports, e.g. a plurality of evenly distributed bulges 68 which may, as desired, be situated on the upper seal element 60 (FIG. 3) or the cover 30.

As most clearly illustrated by the simplified depiction in FIG. 5, the filter unit's 50 filter 52 is also connected to a filter bottom in the form of a lower seal element 70. When the filter unit 50 is fitted in the housing 10, the outer periphery of the lower seal element 70 abuts sealingly against a lower circumferential edge 18 which delineates a bottom aperture 16 (FIG. 3) of the housing. This bottom aperture 16 allows dirt, cleaning agents and other particles to make their way out of the filter housing 10 when it is being cleaned, e.g. on the occasion of change of the filter unit 50. Centering means of the housing 10 and/or the filter bottom 70, e.g. an encircling protrusion 72 directed downwards from the underside of the filter bottom 70, may facilitate and ensure that the filter bottom 70 also reaches a correct position at the lower side of the housing 10.

Although other solutions are possible, the aforesaid cover 30 in FIGS. 1-3 and FIGS. 6-7 is depicted as being connected pivotably to the filter housing 10 via a hinge 38 situated at an upper outside of the housing 10. The cover's 30 air outlet 40 may further be covered by a filter element 34 (FIG. 2), e.g. a filter cloth and/or a fine-mesh grille, to prevent contaminants and solid particles from entering the air ducts 40, 80 when the cover 30 is open. The cover 30 may be fastened to the housing 10 by suitable connecting means, e.g. undepicted tightening screws or other kinds of fastenings.

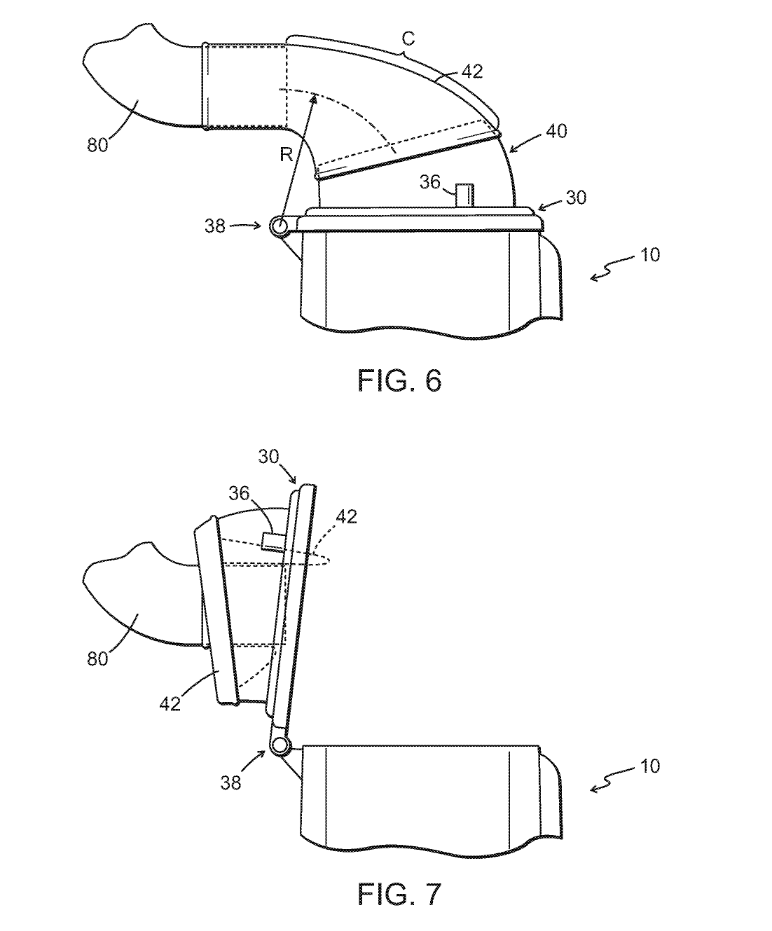

In the embodiment depicted in FIGS. 6 and 7, the air duct 40 situated nearest to the cover 30 is provided with a collapsible or flexible pipe section 42 which allows repeated opening and closing of the cover 30 without removal from or movement of the fixed air duct 80 situated nearest to the engine. In the embodiment depicted, the pipe section 42 is provided with a narrowing curved portion C made of bendable rubber elastic material which, like a roll bellows, allows the larger cross-section nearest to the cover 30 to be turned inside out, with or without help from a service technician, over the narrowing cross-section nearest to the air duct 80, approximately as depicted in FIG. 7, when the cover 30 is being opened. In a functional state, the pipe section 42 is stretched over the engine air outlet 40 and the air duct 80. A middle line of the curved portion may then extend at approximately constant distance R from the cover's hinge 38.

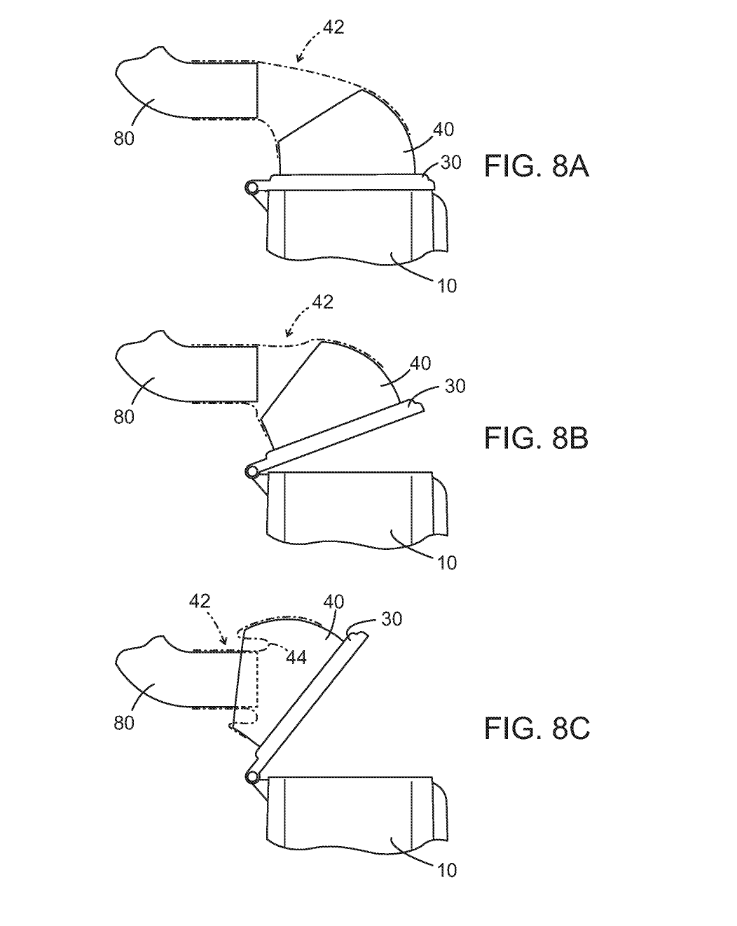

FIGS. 8A-8C depict in more detail an opening process of an arrangement substantially corresponding to that in FIGS. 6 and 7. The air ducts 40 and 80 extend relatively far into the flexible pipe section 42 in order to support it and prevent its collapsing during operation. As indicated in FIG. 8B, the cross-section of the pipe section 42 between the ducts may in various ways, e.g. by material notches or built-in stresses, be arranged to be drawn together somewhat or deformed radially inwards when the cover 30 starts opening. The larger duct 40 connected to the cover 30 will then be situated round and spaced from the narrower duct 80. When thereafter the cover in FIG. 8C approaches the open state which allows an undepicted filter unit to be taken out of the filter housing 10, a roll lobe 44 may naturally form on the portion of the pipe section 42 which is supported on an end portion of the narrower duct 80 so that the pipe section 42 unrolls like a roll bellows on this end portion.

In this and other embodiments, the cover 30 need not necessarily be connected pivotably to the remainder of the housing 10, as it may also in an undepicted way be capable of being completely lifted away from the housing 10.

The detailed description set out above is primarily intended to facilitate understanding and no unnecessary limitations of the invention are to be construed therefrom. The modifications which will be obvious to one skilled in the art from perusing the description may be effected without departing from the concept of the invention or the scope of the claims set out below.

1. A filter housing configured for containing a filter unit having an interior shaped for receiving a substantially semicylindrical air filter;
the housing comprising an air inlet and an engine air outlet;
the housing having a top aperture for introducing and taking out the filter unit from the housing and also having a bottom aperture;
the filter unit having a closed filter bottom; the bottom aperture being configured to be closed and opened by the closed filter bottom of the filter unit being respectively introduced or taken out; and
a cover configured to close the top aperture and to be opened to open the top aperture.

2. A filter housing according to claim 1, further comprising the engine air outlet is situated in the cover.

3. A filter housing according to claim 1, further comprising a filter element covering the engine air outlet.

4. A filter unit configured for being received in a filter housing, the filter housing having an air inlet and an engine air outlet;
the filter unit comprising a substantially semicylindrical air filter;
the filter housing having a bottom aperture; and
a closed filter bottom located and configured to close the bottom aperture of the filter housing when the filter unit is being introduced into the filter housing.

5. A filter unit according to claim 4, further comprising a centering device at a periphery of the filter bottom for engagement with an edge of the bottom aperture.

6. A filter unit according to claim 4, further comprising a filter top with a central aperture for the engine air outlet, and the filter top is arranged to seal the top aperture of the filter housing when the filter unit is being introduced into the filter housing.

7. A filter unit according to claim 6, further comprising an upper side of the filter top configured to cooperate with the cover over the top aperture to define an air aperture; and
an extra air outlet of the filter housing connected to the air aperture and the air aperture extends along a periphery of the engine air outlet.

8. A filter unit according to claim 6, further comprising a centering device at a periphery of the filter top for engagement with an edge of the top aperture.
